(19) United States
(12) Patent Application Publication
(10) Pub. No.: US 2012/0151992 A1
(43) Pub. Date: Jun. 21, 2012

(54) PARTICULATE MATTER DETECTION SENSOR

(75) Inventors: Toshihiko HARADA, Toyohashi-shi (JP); Satoshi Nakamura, Okazaki-shi (JP); Shinya Teranishi, Chita-gun (JP); Eriko Maeda, Okazaki-shi (JP)

(73) Assignee: DENSO CORPORATION, Kariya-city (JP)

(21) Appl. No.: 13/326,655

(22) Filed: Dec. 15, 2011

(30) Foreign Application Priority Data
Dec. 17, 2010 (JP) 2010-281629

(51) Int. Cl. G01M 15/10

(52) U.S. Cl. 73/23.33

(57) ABSTRACT

In a PM detection sensor S having a PM sensor element 1 installed in an exhaust-gas pipe of an engine E/G, PM detection electrodes are placed in detection spaces in slits, respectively, formed in an insulation substrate. In the insulation substrate, one slit is embedded between an electric field generating electrode and a common electric field generating electrode. The other slit is embedded between an electric field generating electrode and the common electric field generating electrode. The same magnitude of an electric field is generated between the detection spaces when electric power is supplied to the electric field generating electrodes. An average value of sensor outputs transferred from the PM detection electrode is used as a sensor output of the PM sensor element.

### CROSS-REFERENCE TO RELATED APPLICATION

This application is related to and claims priority from Japanese Patent Application No. 2010-281629 filed on Dec. 17, 2010, the contents of which are hereby incorporated by reference.

### BACKGROUND OF THE INVENTION

1. Field of the invention

The present invention relates to particulate matter (PM) detection sensors of an electric resistance type, to be used for an exhaust gas purifying system mounted to an internal combustion engine such as a diesel engine. The PM detection sensors detect particulate matter (PM) contained in exhaust gas as a detection target.

2. Description of the Related Art

A diesel engine, for example, mounted to a motor vehicle, is equipped with a diesel particulate filter (hereinafter, referred to as the “DPF”). Such a DPF captures particulate matter (hereinafter, referred to as the “PM”) as environmental pollution matter contained in exhaust gas emitted from the diesel engine. The PM contains soot and soluble organic fraction (SOF). The DPF is composed of a plurality of cells surrounded by partition walls having a plurality of pores. The DPF is made of porous ceramics having superior property of heat resistance. When the DPF is placed in an exhaust gas of an exhaust gas purifying system of an internal combustion engine, and the exhaust gas emitted from the internal combustion engine passes through the pores formed in the partition walls of the DPF, the pores capture PM contained in the exhaust gas in order to purify the exhaust gas.

When a quantity of PM captured by the pores in the partition walls of the DPF is increased and exceeds a predetermined allowable quantity, the pores are clogged and this increases a pressure loss of the DPF. In order to avoid this problem and to regenerate the capturing property of the DPF, it is necessary to periodically regenerate the DPF. In general, the regenerating cycle of the DPF is determined on the basis of the quantity of PM captured in the DPF. It is therefore necessary to place a pressure sensor in the exhaust gas pipe of the exhaust gas purifying system. The pressure sensor is capable of detecting a difference between a pressure at an upstream side and a pressure at a downstream side of the DPF placed in the exhaust gas pipe. The regenerating process heats the exhaust gas or executes a post injection in order to heat the exhaust gas, and introduces the heated exhaust gas into the inside of the DPF. This removes PM captured in the pores in the partition walls of the DPF.

On the other hand, there have been proposed a particulate matter detection sensor (hereinafter, referred to as the “PM detection sensor”) of an electrical resistance type capable of directly detecting the presence of PM contained in exhaust gas. Such a PM sensor has a pair of conductive electrodes formed on a surface of an insulation substrate, and a heating member formed on an opposite surface or in the inside of the insulation substrate. For example, such a PM sensor is placed at the downstream side of the DPF, and detects a quantity of PM contained in the exhaust gas passing through the DPF. An on-board diagnosis (OBD) mounted to a motor vehicle monitors the output of the PM sensor in order to detect the working condition of the DPF, and occurrence of defects and damage of the DPF.

There has been proposed such a DPF placed in an upstream side of the DPF in order to detect the quantity of PM contained in exhaust gas and to determine a regeneration timing of the DPF on the basis of the detected quantity of PM.

In general, an electrical resistance type PM detection sensor has a detection section composed of a pair of electrodes formed in a comb structure. The pair of the electrodes in the detection section is formed on a surface of an insulation substrate. The electrical resistance type PM detection sensor works on the basis of the property that PM has an electrical conductivity. When PM is accumulated on an area between the electrodes of a comb structure, an electrical resistance value between the electrodes of a comb structure is changed. A control device monitors the change of the electrical resistance value between the electrodes formed in a comb structure in the PM detection sensor of an electrical resistance type. Further, the PM detection sensor of an electrical resistance type has a heater section formed in the other surface side of the insulation substrate, which is opposite to the surface of the insulation substrate on which the electrodes of a comb structure are formed. The heater section is embedded in the insulation substrate. The heater section generates heat energy when receiving electric power. The heat energy increases a temperature of the PM detection section to a desired temperature (for example, a temperature within a range of 400° C. to 600° C.), and burns PM accumulated on the area between the electrodes of a comb structure in the detection section. This makes it possible to recover and regenerate the detection capability of the PM detection sensor of an electrical resistance type.

Further, there is an electrical resistance type PM detection sensor having the electrodes formed in a comb structure. In the PM detection sensor of an electrical resistance type, a voltage to be supplied to the electrodes of a comb structure is controlled in order to adjust the quantity of soot accumulated on an area between the electrodes of a comb structure. For example, a conventional patent document 1, Kohyo (National publication of translated version) No. JP 2008-502892, discloses a conventional method of supplying high voltage (for example, 21 volts) to a detection section composed of detection electrodes of a comb structure in a conventional PM detection sensor before a sensor signal output from the conventional PM detection sensor reaches a predetermined current value (as a threshold value) at which an external device can detect the sensor signal. This makes it possible to generate a non-uniform distribution of electric field intensity around each electrode in the detection section, and to accelerate PM toward each electrode. This makes it possible to promote the accumulation of PM on the detection section and to increase the accumulation speed of PM. When the sensor signal reaches the threshold value, the external device switches from supplying high voltage to low voltage (for example, 10 volts), and supplies the low voltage to the detection section in the conventional PM detection sensor in order to extend the time to execute regeneration of the conventional PM detection sensor.

There is another conventional PM detection sensor disclosed in a conventional patent document 2, Japanese patent laid open publication No. JP 2009-186278.

FIG. 9A, FIG. 9B and FIG. 9C, each is a cross section showing a schematic structure of a sensor element in a conventional PM detection sensor. As shown in FIG. 9A, a penetration hole 103 is formed in a sensor element 100, and a pair of electrodes 101 and 102 is embedded in the inside of a wall surface of the penetration hole 103. The electrodes 101 and 102 are covered with dielectric material. In this PM detection sensor shown in FIG. 9A, a voltage is supplied between the electrodes 101 and 102 which form the electrode pair in order to discharge in the inside of the penetration hole 103. PM contained in exhaust gas to be detected is charged by the discharging and captured on the inner wall surface of the penetration hole 103. The external device detects the change of electric characteristics of the wall surface of the penetration hole 103.

There is a PM detection sensor using such a discharging property, disclosed in Japanese patent laid open publication No. JP 2010-32488. The PM detection sensor has a discharging electrode and a detection electrode. As shown in FIG. 9B, a pair of electrodes 104 and 105 is placed in a space in which exhaust gas as a detection target flows. In particular, a pair of detection electrodes 107 and 108 is formed on a surface of dielectric material 106. The detection electrodes 107 and 108 are covered with the electrode 104.

As shown in FIG. 9C, a conventional patent document 4, Japanese patent laid open publication No. JP 2009-276151, discloses a PM detection sensor having a plurality of penetration holes 103 which is formed along a longitudinal direction of an element 100. As shown in FIG. 9C, the structure of the penetration holes 103 increases the entire surface area of the inner walls on which PM is captured and accumulated. This structure of the PM detection sensor shown in FIG. 9C makes it possible to easily detect a change of electrostatic capacitance when a voltage is supplied to the pair of the electrodes 101 and 102.

Recently, air pollution is the introduction of chemicals, particulate matter, or biological materials emitted from internal combustion engines for motor vehicles, etc., that causes harm or discomfort to humans or other living organisms, or causes damage to the natural environment or built environment, into the atmosphere. Pollution control standards act and regulations to chemicals, particulate matter, or biological materials contained in exhaust gas emitted from internal combustion engines for motor vehicles become stricter year by year.

In particular, it is expected to detect PM having a particle size of not more than 10 μm in order to detect a fault of a DPF. On the other hand, these PM having the particle size of not more than 10 μm are condensed on the surface of the inner wall of an exhaust gas pipe through which exhaust gas flows from an internal combustion engine to the outside through the DPF when the internal combustion engine is stopped. When the internal combustion engine is restarted, the condensed PM having a large particle size is separated from the inner wall of the exhaust gas pipe and discharged to the outside.

However, in a usual PM detection sensor of an electrical resistance type, as disclosed in the conventional patent document 1, a pair of detection electrodes of a comb structure formed in a detection section of a PM detection element is exposed to exhaust gas. The detection section in the PM detection element cannot selectively detect and capture PM having a particle size within a predetermined range contained in the exhaust gas. This causes that PM having a large particle size, which has been condensed during the stop of the internal combustion engine, is attached to the electrodes formed in a comb structure. This causes a wrong detection. In addition, when water component contained in the exhaust gas is condensed and attached on the detection electrodes of a comb structure because the detection electrodes of a comb structure are exposed to the flow of the exhaust gas when the internal combustion engine is stopped and the temperature thereof is decreased. This case causes the same problem such as a wrong detection, and a detection error, as previously described.

Further, a quantity of PM captured by and accumulated to each detection electrode is increased when a predetermined electric field is supplied to the detection electrodes, the width of each detection electrode is increased, as described in the conventional patent document 1, the intensity of electric field around the detection electrodes is changed according to the elapse of time. It is therefore difficult to stably provide a predetermined constant electric field to the area around the detection electrodes. This causes a probability of decreasing the detection accuracy of the PM detection sensor.

On the other hand, the structure of the PM detection sensor having a plurality of the penetration holes, as disclosed in the conventional patent document 2, can suppress PM having a large particle size from being entered to and accumulated on the electrodes on the detection section. However, it is difficult for the PM detection sensor disclosed in the conventional patent document 2 to detect a change of electric capacitance with high accuracy caused by the accumulation of PM, in particular, when a fault of the DPF occurs. The structure of the PM detection sensor is requested to have an additional detection electrode pair, as disclosed in the conventional patent document 3, or to have a plurality of the penetration holes, as disclosed in the conventional patent document 4 in order to increase the total area of the capturing surface of the inner walls. Because all of the PM detection sensors disclosed in the conventional patent documents 2, 3, and 4 electrically charge PM by using a discharging process, the energy of the electric power is increased and the total detection cost thereof is increased.

### SUMMARY

It is therefore desired to provide a particle matter detection sensor of an electrical resistance type with high detection accuracy capable of detecting particulate matter contained in exhaust gas emitted from an internal combustion engine. The detection sensor decreases occurrence of wrong detection caused by PM having a huge particle size and condensed water. In addition, the PM detection sensor consumes a low electric power and detects PM with high detection accuracy with a low cost.

An exemplary embodiment provides a particulate matter (PM) detection sensor S equipped with a PM sensor element capable of detecting presence of PM contained in exhaust gas as a detection target. The PM sensor element has a pair of PM detection electrodes formed in the inside of an insulation substrate. The PM sensor element has a plurality of detection units. Each detection unit has a detection space, a PM detection electrode, and a pair of electric field generating electrode and a common electric field generating electrode. The detection spaces are formed by the slits, respectively, and penetrated through the insulation substrate. Each of the PM detection electrodes has a pair of electrodes. The electrodes are formed on a surface of an inner wall of the slit. The slits form the detection spaces, respectively. A predetermined electric field is generated in the inside of the detection spaces by the electric field generating electrodes and the common electric field generating electrode.

In the PM sensor element 1, the slits form the detection units and are arranged at a predetermined interval in a thickness direction of the insulation substrate. One slit is sandwiched between the pair of the electric field generating electrode and the common electric field generating electrode. The other slit is sandwiched between the pair of the electric field generating electrode and the common electric field generating electrode. The insulation substrate is placed in an exhaust gas flow during detection of PM contained in the exhaust gas, and PM contained in the exhaust gas is detected on the basis of detection results transferred from the pair of the PM detection electrodes.

### BRIEF DESCRIPTION OF THE DRAWINGS

A preferred, non-limiting embodiment of the present invention will be described by way of example with reference to the accompanying drawings, in which:

FIG. 1A to FIG. 1E are view showing a schematic structure of a PM sensor element in a PM detection sensor according to a first exemplary embodiment of the present invention;

FIG. 1A shows a front view of the PM sensor element;

FIG. 1B shows a side view of the PM sensor element;

FIG. 1C shows a cross section along the line A-A′ shown in FIG. 1A;

FIG. 1D shows a cross section along the line B-B′ shown in FIG. 1B;

FIG. 1E shows a cross section along the line C-C′ shown in FIG. 1B;

FIG. 2A shows a cross section of an area between the line D-D′ and the line E-E′ shown in FIG. 1B;

FIG. 2B shows a cross section along the line F-F′ shown in FIG. 1B;

FIG. 2C is an explanatory view showing a relationship between a supplying voltage to be supplied to electric field generating electrodes and an electric field generated by the supplied voltage;

FIG. 3A is an enlarged cross section showing a state in which the PM detection sensor is mounted to an exhaust gas pipe in an exhaust gas purifying system;

FIG. 3B is a schematic view showing an entire structure of the exhaust gas purifying system for a motor vehicle diesel engine (E/G) system to which the PM detection sensor according to the first exemplary embodiment is mounted;

FIG. 4A shows a cross section of the PM sensor element in the PM detection sensor according to the first exemplary embodiment of the present invention;

FIG. 4B shows a cross section of a PM sensor element without a common electric field generating electrode as a comparative example;

FIG. 5 is an exploded view showing a PM sensor element in according to a second exemplary embodiment of the present invention;

FIG. 6A shows a cross section of a first element as a comparative element;

FIG. 6B shows a cross section of a second element according to the second exemplary embodiment of the present invention;

FIG. 6C is a graph showing fluctuation of an sensor output of the first element shown in FIG. 6A and the second element shown in FIG. 6B as a first example according to the second exemplary embodiment;

FIG. 7A is a view showing a relationship between a quantity of PM emitted from an internal combustion engine and a sensor output of the first element in the first experiment according to the second exemplary embodiment;

FIG. 7B is a view showing a relationship between a quantity of PM emitted from the internal combustion engine and a sensor output of the second element in the first experiment according to the second exemplary embodiment;

FIG. 8A is an explanatory view showing a breaking of a wire such as a lead part of an electrode in each of the first element and the second element by using a laser trimmer used in the second experiment;

FIG. 8B is a view showing a relationship between a quantity of PM contained in exhaust gas and a sensor output of the first element used in the second experiment;

FIG. 8C is a view showing a relationship between a quantity of PM contained in exhaust gas and an averaged sensor output supplied from the second element used in the second experiment;

FIG. 8D is a view showing a relationship between a PM contained in exhaust gas and a sensor output of the second element used in the second experiment; and

FIG. 9A, FIG. 9B and FIG. 9C, each is a cross section showing a schematic structure of a sensor element in a conventional PM detection sensor.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Exemplary Embodiment

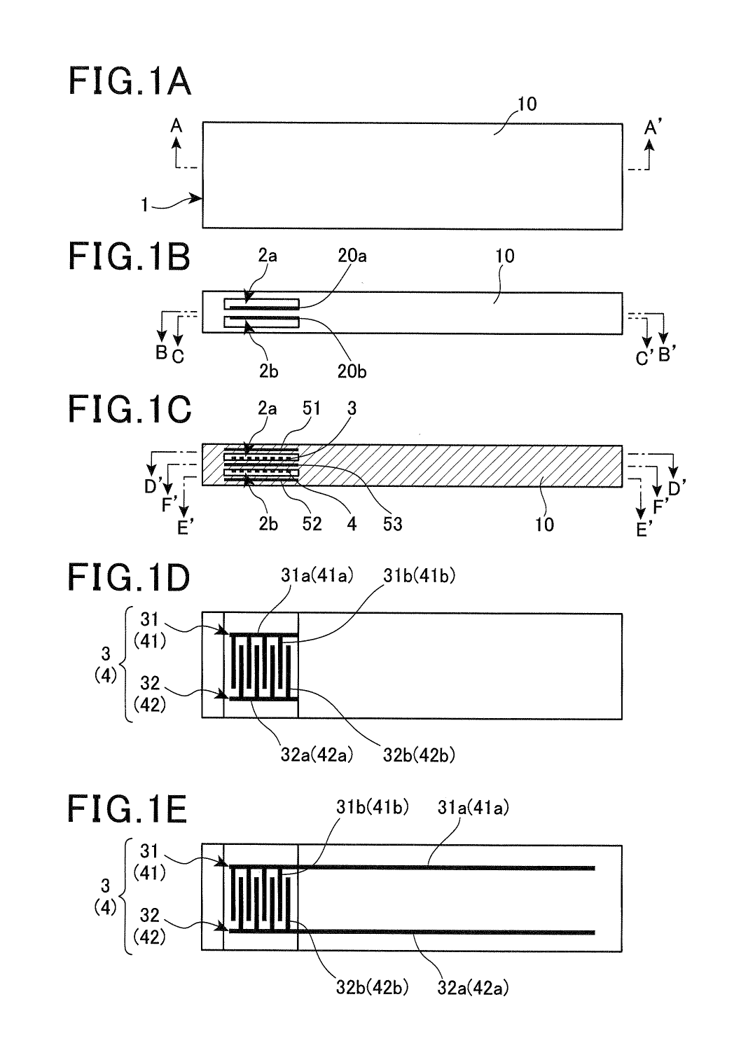

A description will be given of the particulate matter detection sensor (PM detection sensor) according to a first exemplary embodiment of the present invention with reference to FIG. 1A to FIG. 3B.

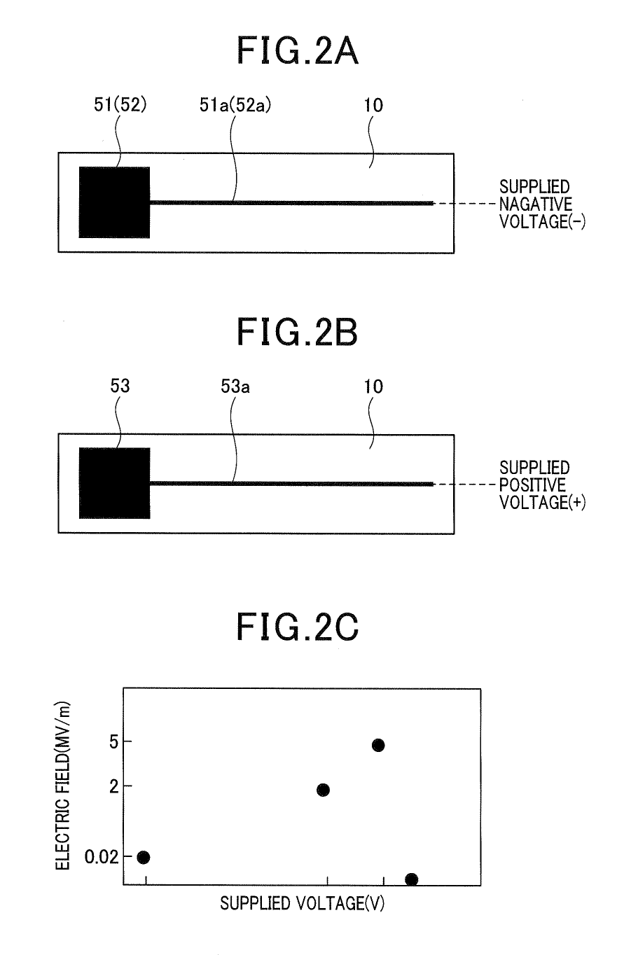

FIG. 1A to FIG. 1E show a schematic structure of a PM sensor element 1 in the PM detection sensor S according to an exemplary embodiment of the present invention. The PM sensor element 1 is a main component of the PM detection sensor S. FIG. 2A to FIG. 2C show a schematic action of the PM sensor element 1 in the PM detection sensor S.

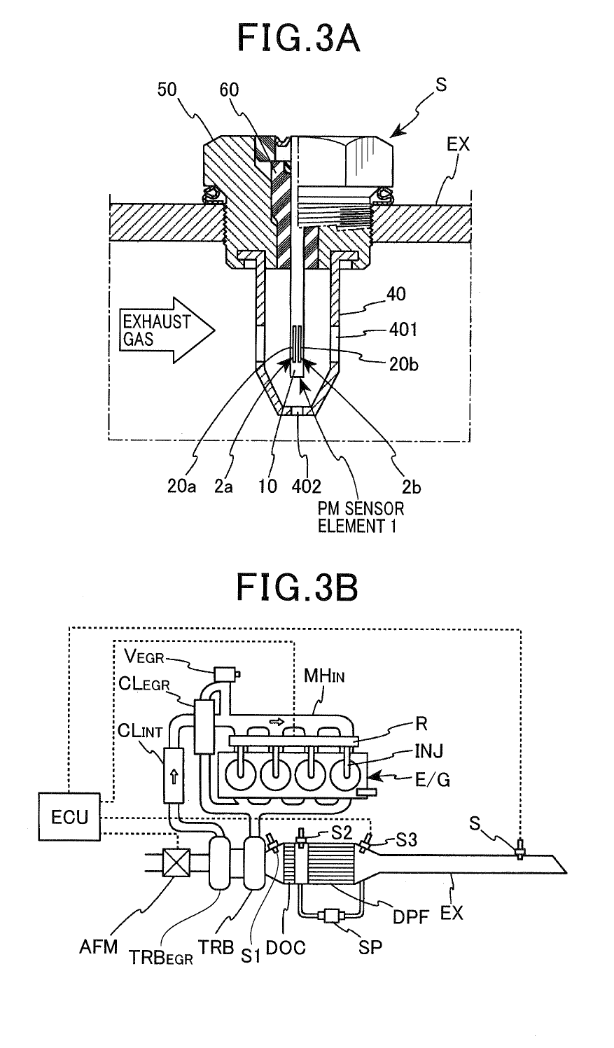

FIG. 3A is an enlarged cross section showing a state in which the PM detection sensor S is installed into an exhaust gas pipe in an exhaust gas purifying system for a motor vehicle diesel engine diesel engine (E/G) system. FIG. 3B is a schematic view showing an entire structure of the exhaust gas purifying system for the motor vehicle E/G system to which the PM detection sensor S according to the exemplary embodiment is installed.

The diesel engine E/G shown in FIG. 3B has a common rail fuel injection system capable of storing a high pressure fuel in a common rail R. The high pressure fuel is generated by a high pressure pump. The common rail R is connected to each of cylinders of the diesel engine E/G as an internal combustion engine. The diesel engine E/G is a direct injection engine capable of directly injecting a high pressure fuel supplied from the common rail R into the inside of each of cylinders through a corresponding injector INJ.

As shown in FIG. 3B, the PM detection sensor S is placed at a downstream side of the diesel particulate filter (DPF) in an exhaust gas pipe EX of the exhaust gas purifying system for the diesel engine E/G. An electric control unit (ECU) controls the operation of each of the PM detection sensor S and the diesel engine E/G. The ECU receives a sensor signal transferred from the PM detection sensor S and detects the presence of PM contained in the exhaust gas as a detection target on the basis of the received sensor signal. The ECU further detects occurrence of fault of the PM detection sensor S. This property of the ECU will be explained in detail later.

A description will now be given of the structure of the diesel engine E/G system with reference to FIG. 3B.

A turbine TRB is mounted to an exhaust gas manifold of the diesel engine E/G. When a supercharger TRB_{CGR} rotates when the turbine TRB rotates, compressed air is transmitted to an inlet manifold MH_{IN} through an intercooler CLR_{INT}. A part of combustion exhaust gas discharged from the exhaust manifold MH_{Ex} is feedback to the inlet manifold MH_{IN} through an EGR valve V_{EGR} and an EGR cooler CLR_{EGR}. This makes it possible to increase the combustion efficiency of the diesel engine E/G by increasing the total quantity of inlet air by the above supercharging and to relax the combustion by the EGR in order to suppress nitrogen oxide NOx, etc. from being discharged to the outside of the diesel engine E/G.

A diesel oxidation catalyst DOC and a diesel particulate filter DPF are mounted to the exhaust gas pipe EX communicated with the exhaust manifold MH_{EX} in order to purify the exhaust gas emitted from the diesel engine E/G. That is, hydrocarbon HC, carbon monoxide CO, and nitric monoxide NO as unburned material contained in the combustion exhaust gas are oxidized by the diesel oxidation catalyst DOC. Further, soot, soluble organic fraction (SOF) and particulate matter (PM) composed of inorganic components are captured by the diesel particulate filter DPF.

The diesel oxidation catalyst DOC is composed of a known monolith supporting body and oxidation catalyst. The monolith supporting body supports the oxidation catalyst thereon. The monolith supporting body is composed of a ceramic honeycomb structural body made of cordierite, etc. During the forced regeneration process of regenerating the DPF, fuel is burned in order to increase the temperature of exhaust gas, and SOF components in PM contained in the exhaust gas are oxidized and removed. Further, NO₂ generated by oxidizing NO is used as oxidizing agent capable of oxidizing PM accumulated in the DPF placed at the downstream side of the DOC. This makes it possible to continuously use the DPF for a long period of time.

The DPF has a known filter structure of a wall flow type. For example, a porous ceramic honeycomb structural body is made of heat resistance ceramics such as cordierite. The porous ceramic honeycomb structural body had a plurality of cells along the longitudinal direction thereof. That is, each cell is partitioned by cell walls. The cells on one surface of the porous ceramic honeycomb structural body are alternately plugged by plug members arranged in a checkered pattern. The cells on the other surface of the porous ceramic honeycomb structural body are alternately plugged by plug members so that exhaust gas flows through the partition walls between the adjacent cells. That is, the cells form a plurality of gas flow passages. The exhaust gas is introduced from one surface of the porous ceramic honeycomb structural body, passed from one cell to the adjacent cell through the partition walls, and finally exhausted from the other surface of the porous ceramic honeycomb structural body. Catalyst is supported on the surface of the partition walls. PM contained in the exhaust gas is captured by the partition walls in the porous ceramic honeycomb structural body by the catalyst on the partition walls.

It is also possible to make a continuously regenerating type DPF composed of a combination of the DOC and the DPF.

The exhaust gas pipe EX is equipped with a differential pressure sensor SP in order to monitor a quantity of PM accumulated in the DPF. The differential pressure sensor SP is communicated with the upstream side and the downstream side of the DPF through a pressure introduction pipe. The differential pressure sensor SP outputs a detection signal corresponding to a detected pressure difference. Temperature sensors S1, S2 and S3 are placed at the upstream side and the downstream side of the DPF in order to monitor a temperature thereof.

The ECU monitors the activation condition of the DOC and the PM capturing condition of the DPF on the basis of the sensor signal transferred from the differential pressure sensor SP and the temperature information transferred from the temperature sensors S1, S2 and S3, etc.

When the quantity of PM captured by and accumulated in the DPF exceeds a predetermined quantity, the ECU forcedly regenerates the DPF in order to burn and remove the accumulated PM from the DPF. Further, the ECU receives various sensor signals, for example, transferred from an air flow meter AFM capable of detecting a quantity and a temperature of inlet air, a temperature sensor capable of detecting a temperature of engine lubricant oil and a temperature of cooling water, an engine rotation sensor capable of detecting a rotational speed of the diesel engine E/G, and a throttle sensor capable of detecting an opening rate of a throttle valve, etc. The ECU calculates a fuel injection quantity, a fuel injection time on the basis of the above received signals and information in order to control the fuel injection.

As shown in FIG. 3A, the PM detection sensor S according to the exemplary embodiment has a housing 50 of a cylindrical shape (hereinafter, referred to as the “cylindrical housing 50”) which is screwed and fixed to the wall of the exhaust gas pipe. In the structure of the PM detection sensor S, an upper half of the PM sensor element 1 is inserted into and fixed to a cylindrical insulator 60 which is installed in the inside of the cylindrical housing 50. The bottom half of the PM sensor element 1 is installed in the inside of a hollow cover body 40. The hollow cover body 40 is fixed to the lower part of the cylindrical housing 50 and exposed to the inside of the exhaust gas pipe EX. A plurality of through holes 401 and 402 is formed in the base part and the side part of the hollow cover body 40. Through the through holes 401 and 402, exhaust gas as a detection target containing PM, which has been passed through the DPF, is introduced into and discharged from the inside of the PM detection sensor S.

The PM sensor element 1 assembled in the PM detection sensor S according to the exemplary embodiment shown in FIG. 3B detects the presence of PM contained in exhaust gas, which has been passed through the DPF and flows toward the downstream of the DPF. A plurality of slits 20a and 20b is formed at the front part (at the bottom part in FIG. 3A) of an insulation substrate 10 in the PM sensor element 1. The insulation substrate 10 has an approximate rectangle shape. The slits 20a and 20b make detection spaces 2a and 2b in which PM contained in the exhaust gas is detected. Detection electrodes (not shown) are formed on the surface of the inner wall of the detection spaces 2a and 2b. The detection electrodes detect the presence of PM contained in the exhaust gas. The detection electrodes make a plurality of detection unit pairs (FIG. 3A shows the two detection units only).

A description will now be given of the detailed structure of the PM sensor element 1 which is one of features of the exemplary embodiment with reference to FIG. 1A to FIG. 1E. In more detail, FIG. 1A shows a front view of the PM sensor element 1 and FIG. 1B shows a side view of the PM sensor element 1. Further, FIG. 1C shows a cross section along the line A-A′ shown in FIG. 1A and FIG. 1D shows a cross section along the line B-B′ shown in FIG. 1B. FIG. 1E shows a cross section along the line C-C′ shown in FIG. 1B.

As shown in FIG. 1A to FIG. 1E, the PM sensor element 1 has the insulation substrate 10 made of a ceramic body. The insulation substrate 10 has a predetermined thickness and a rectangle shape. The slits 20a and 20b are formed at one side (at the left side shown in FIG. 1B) and penetrate in the inside of the insulation substrate 10 in the width direction of the insulation substrate 10. The slits 20a and 20b are open in the wide direction at both sides of the insulation substrate 10. The two slits 20a and 20b are arranged adjacent to each other in parallel along the thickness direction of the insulation substrate 10. The inside of the slit 20a forms a detection space 2a. Similarly, the inside of the slit 20b forms a detection space 2b. Each of the detection spaces 2a and 2b is an oblate space formed between the surfaces of first inner walls and the surfaces of second inner walls of the insulation substrate 10. The first inner walls are faced to each other in the longitudinal direction of the insulation substrate 10. The second inner walls are faced to each other in the thickness direction of the insulation substrate 10.

The exhaust gas is introduced into the detection spaces 2a and 2b through the openings formed at both side surfaces of the insulation substrate 10. In the structure of the insulation substrate 10 shown in FIG. 1B, the pair of the surfaces of the inner walls, which are adjacent to each other in the thickness direction, makes the detection surface capable of detecting PM contained in the exhaust gas.

As shown in FIG. 1C and FIG. 1D, a PM detection electrode 3 is formed on the surface of the first inner wall at the bottom side in the detection space 2a. The PM detection electrode 3 is composed of a pair of electrodes 31 and 32 formed in a comb structure. Similarly, a PM detection electrode 4 is formed on the surface of the first inner wall at the upper side in the detection space 2b. The PM detection electrode 4 is composed of a pair of electrodes 41 and 42 formed in a comb structure. That is, the insulation substrate 10 of the PM sensor element 1 has the two pairs of the electrodes. One pair of the electrodes is formed in a comb structure on the detection surfaces in the detection space 2a. The other pair of the electrodes is formed in a comb structure on the detection surfaces in the detection space 2b.

The pair of the electrodes 31, 32 formed in a comb structure in the PM detection electrode 3 has the same shape of the pair of the electrodes 41, 42 formed in a comb structure in the detection electrodes 4. As clearly shown in FIG. 1D, the PM detection electrode 3 is composed of the electrodes 31 and 32 formed in a comb structure. The electrodes 31 and 32 formed in a comb structure are arranged face to each other at a predetermined distance or gap. In more detail, the electrode 31 is composed of a base part 31a and a plurality of auxiliary electrodes 31b extending from the base part 31a toward a base part 32a in the electrode 32. The electrode 32 is composed of the base part 32a and a plurality of auxiliary electrodes 32b extending from the base part 32a toward the base part 31a of the electrode 31. Similarly, the PM detection electrode 4 is composed of electrodes 41 and 42 formed in a comb structure. The electrode 41 is composed of a base part 41a and a plurality of auxiliary electrodes 41b extending from the base part 41a toward a base part 42a of the electrode 42. The electrode 42 is composed of the base part 42a and a plurality of auxiliary electrodes 42b extending from the base part 42a toward the base part 41a of the electrode 41.

For example, the insulation substrate 10 is made of oxide ceramics such as alumina having superior electric insulation and a superior heat resistance. The PM detection electrodes 3 and 4 are made of conductive paste containing noble metal such as platinum Pt. The conductive paste is printed in a predetermined detection pattern on the surface of the insulation substrate 10.

As shown in FIG. 1E, the base parts 31a, 32a, 41a and 42a of the electrodes 31, 32, 41 and 42 of a comb structure extend to the other end part (at the right side in FIG. 1E) of the insulation substrate 10. At the other end part of the insulation substrate 10, each of the base parts 31a, 32a, 41a and 42a is connected to an output terminal or a power source terminal (not shown). The output terminal is connected to an outside control device (not shown) such as an electric control unit (ECU). The power source terminal is connected to an electric power source. The electrodes 31 and 32 are formed face to each other in a comb structure at a predetermined distance or gap. Similarly, the electrodes 41 and 42 are formed face to each other in a comb structure at a predetermined distance or gap. When PM is not accumulated or PM of not more than a predetermined quantity is accumulated on the surfaces of the inner walls of the detection space 2 during the initial state of the PM detection sensor S, no current flows between the electrodes 31 and 32 and between the electrodes 41 and 42.

When exhaust gas containing PM with conductive soot flows through the detection spaces 2a and 2b and the PM is contacted with and accumulated on the surfaces of the inner walls on which the electrodes in a comb structure are formed, current flows between the electrodes 31, 32 and 41 and 42. When the quantity of PM accumulated on the surfaces of the inner walls of the detection spaces 2a and 2b is gradually increased, an electrical resistance value between the electrodes is decreased. Because the electrical resistance between the electrodes is changed depend on the quantity of PM accumulated on the area between the electrodes, it is possible to detect the quantity of PM contained in the exhaust gas which flows in the downstream side of the DPF on the basis of the above relationship. It is therefore for the ECU to diagnose occurrence of a faulty DPF on the basis of the detected quantity of PM.

Electric field generating electrodes 51 and 52 are formed at the upper part and the bottom part of the slits 20a and 20b. When receiving electric power, the electric field generating electrodes 51 and 52 generates an electric field. The slits 20a and 20b are formed at one end (at the left side in FIG. 1C) of the insulation substrate 10 shown in FIG. 1C. The slits 20a and 20b have the same shape. The two pairs of the detection electrodes (the pair of the PM detection electrodes 3 and 4) are formed in the slits 20a and 20b.

The electric field generating electrode 51 is embedded at the slit 20a side (at the upper side in FIG. 1C) close to the PM detection electrode 3 in the insulation substrate 10. On the other hand, the electric field generating electrode 52 is embedded at the slit 20b side (at the bottom side in FIG. 1C) close to the PM detection electrode 4 in the insulation substrate 10. In the structure of the insulation substrate 10, a common electric field generating electrode 53 is embedded between the slits 20a and 20b as the detection spaces 2a and 2b in the insulation substrate 10.

FIG. 2A shows a cross section of an area between the line D-D′ and the line E-E7 shown in FIG. 1B. FIG. 2B shows a cross section along the line F-F′ shown in FIG. 1B.

As shown in FIG. 2A, each of the electric field generating electrodes 51 and 52 is composed of an electrode film of a rectangle pattern which corresponds to the formation area of the pair of the PM detection electrodes 3 and 4. The electric field generating electrodes 51 and 52 have the same shape and the same electric polarity (negative) connected to a common terminal (not shown) through lead parts 51a and 52a, respectively. As shown in FIG. 2a, these lead parts 51a and 52a are extended toward the other side (at the right side in FIG. 2A) of the insulation substrate 10. An external power source (not shown) supplies electric power of a predetermine voltage to the electric field generating electrodes 51 and 52 through the common terminal and the lead parts 51a and 52a.

As shown in FIG. 2B, the common electric field generating electrode 53 is formed at the position corresponding to the electric field generating electrode 51 through the detection space 2a and at the position corresponding to the electric field generating electrode 52 through the detection space 2b. The common electric field generating electrode 53 is composed of a rectangle electrode film and a lead part.

The common electric field generating electrode 53 has the same shape of the electric field generating electrodes 51 and 52, and has a polarity (positive) which is opposite to the polarity (negative) of the electric field generating electrodes 51 and 52.

The structure composed of the common electric field generating electrode 53 and the electric field generating electrodes 51 and 52 makes it possible to easily form the two pairs of the electric field generating electrodes capable of supplying an electric field to the detection spaces 2a and 2b in which the pair of the PM detection electrodes 3 and 4 is formed.

Because exhaust gas generally contains only a small quantity of PM, if there is only one pair of detection electrodes, there is a probability of causing fluctuation of detection results output from the PM detection sensor S. In order to avoid such fluctuation of the detection results, the PM detection sensor S according to the exemplary embodiment has a plurality of the detection spaces 2a and 2b and a pair of the PM detection electrodes 3 and 4 having a plurality of the electrodes formed in a comb structure. Further, the PM detection sensor 1 has a plurality of the detection units of the same structure in which the electric field generating electrodes 51 and 52 are independently formed.

Specifically, the PM sensor element 1 in the PM detection sensor S has the pair of the detection spaces 2a and 2b, and the pair of the PM detection electrodes 3 and 4. Each of the PM detection electrodes 3 and 4 has the pair of the electrodes 31 and 32 (41 and 42) of a comb structure. The PM sensor element 1 further has the two pairs of the electric field generating electrodes. That is, one pair is composed of the electric field generating electrodes 51 and 53. The other pair is composed of the electric field generating electrodes 52 and 53. When a negative voltage (−) is supplied to the electric field generating electrodes 51 and 52, and a positive voltage (+) is supplied to the electric field generating electrode 53, a uniform electric field is generated around the PM detection electrodes 3 and 4 in the detection spaces 2a and 2b. Because the three electric field generating electrodes 51, 52 and 53 are embedded in the inside of the insulation substrate 10, the accumulation of PM does not affect any influence to the electric field generating electrodes 51, 52 and 53, and this structure of the PM sensor element 1 makes it possible to continuously generate a constant uniform electric field around the PM detection electrodes 3 and 4.

Because charged PM contained in the exhaust gas which flows in the exhaust gas pipe usually reaches the PM detection sensor S, the charged PM is captured by the generated electric field when the exhaust gas is introduced in the detection spaces 2a and 2b. When the PM captured by the electric field reaches the detection electrodes 3 and 4, the electrodes of a comb structure forming the PM detection electrodes 3 and 4 detect the presence of the charged PM. In the exemplary embodiment, the ECU receives the sensor output transferred from the PM detection electrodes 3 and 4 formed in the detection spaces 2a and 2b, and averages the received sensor output as a sensor output. The ECU suppresses the detection result of the PM detection sensor S on the basis of the averaged sensor output. This structure makes it possible for the PM detection sensor S to output a stable sensor output and to increase the detection accuracy thereof.

Because the detection electrodes have a plurality of the pairs of the electrodes formed in a comb structure, it is possible to detect occurrence of fault of the PM sensor element 1 such as electrode damage and breaking. Specifically, when the PM detection electrodes 3 and 4 are formed in the detection spaces 2a and 2b, respectively and one of the PM detection electrodes 3 and 4 is broken, one PM detection electrode does not output any sensor output and the other PM detection electrode outputs a sensor output even if PM of the same quantity is accumulated on each of the PM detection electrodes 3 and 4. In this case, it is possible to compare one sensor output with the other sensor output. The ECU can detect the occurrence of abnormal state or a fault state of the PM detection sensor when a difference between the sensor outputs from the PM detection electrodes 3 and 4 exceeds a predetermined value.

As shown in FIG. 3A, although the PM detection sensor S usually has the hollow cover body 40, it is generally difficult for the PM detection sensor S to completely prevent huge particles separated from the exhaust gas pipe EX and condensed water from being entered into the inside of the hollow cover body 40. A conventional PM detection sensor having a detection part which is directly exposed to exhaust gas as a detection target cannot eliminate the influence of high PM, condensed water, etc. On the other hand, because the PM detection sensor S according to the exemplary embodiment has the slits 20a and 20b as the detection spaces 2a and 2b in the PM sensor element 1, this structure makes it possible to prevent huge PM contained in exhaust gas from being entered into the inside of the PM sensor element 1. That is, it is possible to form the PM detection sensor S according to the particle size of PM to be detected. In other words, the present invention can provides the PM detection sensor having the property of classifying the size of PM to be detected. Still further, the structure of the PM detection sensor S can stably generate a predetermined constant electric field in the detection spaces 2a and 2b. This makes it possible to accumulate PM contained in the exhaust gas as a detection target with high efficiency. Because the ECU calculates an averaged value of sensor outputs transferred from the PM detection sensor S and uses the averaged sensor output value, the ECU can detect the presence of PM contained in the exhaust gas with high accuracy.

FIG. 2C is an explanatory view showing a relationship between a supplying voltage to be supplied to the electric field generating electrodes 51 and 52 and an electric field generated by the supplied voltage.

When PM is accumulated on the pair of the PM detection electrodes 3 and 4, the more the electric field generated in the detection spaces 2a and 2b is increased, the more the quantity of PM captured by the PM detection electrodes 3 and 4 is increased. However, this consumes a large amount of electric power. As clearly shown in FIG. 2C, when the supplying voltage is increased, the generated electric field is increased, and the quantity of captured PM is also increased. However, in the zone of less than 0.02 MV/m of the electric field, the PM detection sensor does not capture PM with a high efficiency. On the other hand, in the zone of more than 5 MV/m of the electric field, an arc is generated according to Paschen's law. Accordingly, it is preferable to generate electric field within a range of 0.02 MV/m to 5.0 MV/m, in more preferably, within a range of 0.2 MV/m to 2.0 MV/m. The above range of the electric field makes it possible to make the property for capturing PM contained in the exhaust gas as a detection target compatible with the cost of electric power.

Still further, because the PM detection sensor S according to the first exemplary embodiment has the two detection spaces 2a and 2b, this structure makes it possible to increase the size of the space to introduce exhaust gas containing PM, and it is possible for the PM detection electrodes 3 and 4 placed in the detection spaces 2a and 2b to capture PM contained in the exhaust gas with high accuracy.

Accordingly, this structure of the PM detection sensor S makes it possible to detect PM contained in exhaust gas with high accuracy when compared with the structure of a conventional PM detection sensor in which exhaust gas is introduced only into a single detection space and PM contained in the exhaust gas is detected by a pair of PM detection electrodes placed in the single detection space.

Because the PM detection sensor according to the exemplary embodiment has the common electric field generating electrode 53, it is possible to form the electric field generating electrode pair composed of the electric field generating electrodes 51 and 52 and the common electric field generating electrode 53, and to detect PM contained in the exhaust gas with high efficiency. The effects of the PM detection sensor S according to the exemplary embodiment will be explained later.

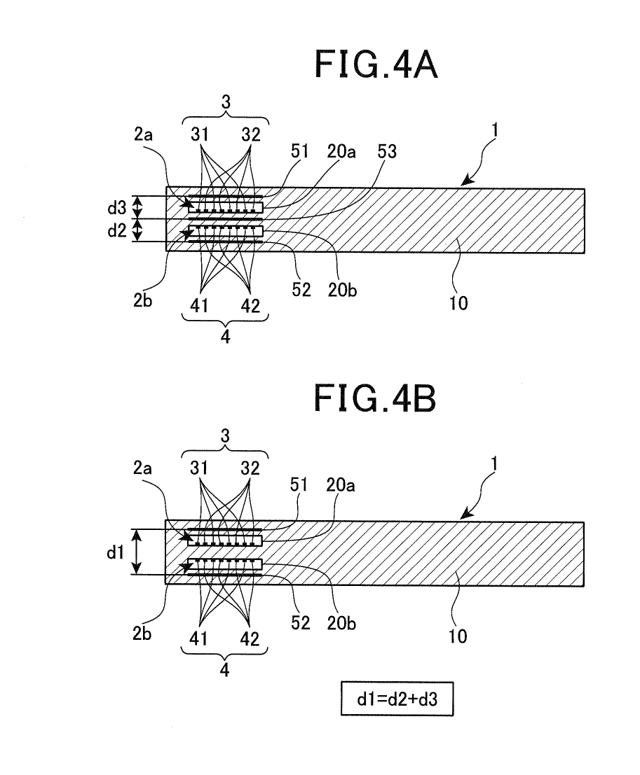

FIG. 4A shows a cross section of the PM sensor element 1 in the PM detection sensor S according to the exemplary embodiment and FIG. 4B shows a cross section of a PM sensor element without the common electric field generating electrode as a comparative example.

The PM sensor element as a comparative example shown in FIG. 4B has a structure in which two slits 20a and 20b are formed in parallel to the thickness direction of the PM sensor element. Each of the slits 20a and 20b is a through hole which penetrates in a front part (at the left side shown in FIG. 4A) of the insulation substrate in the PM sensor element. The slits 20a and 20b have detection spaces 2a and 2b, respectively. In the inside of the slit 20a, a PM detection electrode 3 is formed. In the inside of the slit 20b, a PM detection electrode 4 is formed. The PM detection electrodes 3 and 4 form a PM detection electrode pair. An electric field generating electrode 51 is formed at the upper part of the detection space 2a. That is, the electric field generating electrode 51 is embedded in the insulation substrate 10 at the upper part of the detection space 2a. An electric field generating electrode 52 is formed at the lower part of the detection space 2b. That is, the electric field generating electrode 52 is embedded in the insulation substrate 10 at the lower part of the detection space 2b. The electric field generating electrode 51 and the electric field generating electrode 52 form an electrode pair.

The PM sensor element shown in FIG. 4B has no electric field generating electrode 53 in the inside of the insulation substrate between the slits 20a and 20b as the detection spaces 2a and 2b. An external control device (ECU, etc.) can adjust a voltage to be supplied to the pair of the electric field generating electrodes 51 and 52 in order to generate an electric field in the detection spaces 2a and 2b.

When a distance or gap between the electric field generating electrodes 51 and 52 in the structure of the PM sensor element shown in FIG. 4B as the comparative example is designated by the reference character “d1”, the more the distance between the electric field generating electrodes 51 and 52 is decreased, the more the magnitude of the generated electric field is increased. This can be expressed by the following equation.

E=V/d, where “E” is an electric field intensity, “V” is a supplied voltage, and “d” is the distance the electric field generating electrodes.

In the structure of the PM sensor element 1 shown in FIG. 4A, when the distance d1 between the electric field generating electrode 51 and the electric field generating electrode 52 has a constant value, the following relationship is satisfied.

d1=d2+d3,

where d2 indicates a distance between the electric field generating electrode 51 and the common electric field generating electrode 53, and d3 indicates a distance between the electric field generating electrode 52 and the common electric field generating electrode 53.

Accordingly, when the same electric field intensity is supplied to the detection spaces in the structure shown in each of FIG. 4A and FIG. 4B, it is possible for the structure of the PM detection sensor S shown in FIG. 4A to generate the same electric field by using the voltage to be supplied to the detection spaces 2a and 2b, which is smaller than the voltage to be supplied to the detection spaces in the structure shown in FIG. 4B without any common electric field generating electrode 53 between the electric field generating electrode 51 and the electric field generating electrode 52. Because the structure of the PM detection sensor S shown in FIG. 4A generates the same electric field intensity by using a small voltage, it is possible to decrease the energy cost.

### Second Exemplary Embodiment

A description will be given of a PM sensor element 1-1 according to a second exemplary embodiment of the present invention.

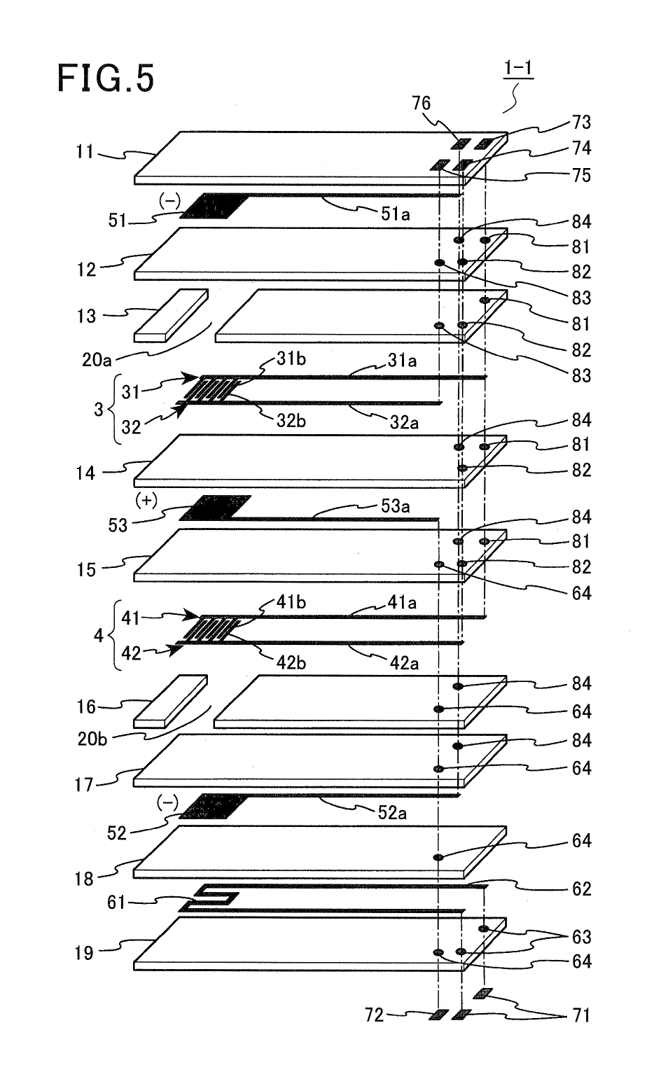

FIG. 5 is an exploded view showing the PM sensor element in the PM sensor element 1-1 according to the second exemplary embodiment of the present invention.

The PM sensor element 1-1 according to the second exemplary embodiment has a heater part 6 in addition to the structure of the PM sensor element 1 according to the first exemplary embodiment shown in FIG. 1A to FIG. 1E. That is, components of the PM sensor element 1-1 other than the heater part 6 shown in FIG. 5 are the same of the components of the PM sensor element 1 shown in FIG. 1A to FIG. 1E. The heater part 6 in the PM sensor element 1-1 will be explained.

The insulation substrate 10 in the PM sensor element 1-1 has the slits 20a and 20b corresponding to the detection spaces 2a and 2b, insulation layers 11 to 17 in which the pair of the PM detection electrodes 3 and 4 and the electric field generating electrodes 51 and 52 are formed, and insulation layers 18 and 19 which form the heater part 6. Each of the insulation layers 11 to 19 is formed in a predetermined plate shape with ceramic material such as alumina having superior electric insulation characteristics and a superior heat resistance by a known method such as the doctor blade method. It is possible to use oxide ceramics or carbide ceramics other than alumina in order to make the insulation substrates 11 to 19 having a predetermined plate shape.

The heater part 6 is composed of the insulation layers 18 and 19 and a heating film 61. The heating film 61 is formed between the insulation layers 18 and 19. The heating film 16 is printed in a predetermined pattern at a front part (at the left part in FIG. 5) of the insulation layer 19 and directly under the pair of the PM detection electrodes 3 and 4 and the electric field generating electrodes 51 and 52. A pair of lead parts 62 is printed and extends toward the other end part (at the right side in FIG. 5) of the insulation layer 19.

The end part of the pair of the lead parts 62 is connected to a pair of heating body terminal parts 71 formed in the lower surface of the insulation layer 19 through a pair of through holes 62. The through holes 62 formed in the insulation layer 19 are filled with conductive material. The heating body 61 is made of Tungsten W, Titanium Ti, Copper Cu, etc.

The heating film 61 receives electric power supplied through the heating body terminal parts 71 which are connected to an external power source (such as a battery mounted to a motor vehicle. etc.). When receiving the electric power, the heating film 61 generates heat energy and adjusts the temperature of the PM sensor element 1-1. This increases the temperature of the pair of the detection electrodes 3 and 4 within a predetermined temperature range during the PM detection. Further, this makes it possible to regenerate the PM sensor element 1-1 by burning PM accumulated in the PM sensor element 1-1 and removing the PM from the PM sensor element 1-1.

The electric field generating electrode 52 is printed in a predetermined pattern on the insulation layer 18 at the upper position of the heating film 61. The insulation layer 17 is laminated on the insulation layer 18 with the electric field generating electrode 52. That is, the insulation layer 17 is sandwiched between the insulation layers 17 and 18. The lead part 52a of the electric field generating electrode 52 is connected to an electric field generating electrode terminal 76 formed on the upper surface of the insulation layer 11 through a through hole 84 formed at the end part (at the right side in FIG. 5) of the insulation layers 12 to 17. The slit 20b is formed in the insulation layer 16 at the upper side of the insulation layer 17. This slit 20b corresponds to the pair of the PM detection electrode 4 composed of the electrodes 41 and 42 formed in a comb structure. The insulation layer 16 is sandwiched between the insulation layer 15 and the insulation layer 17 in order to make the detection space 2b.

The common electric field generating electrode 53 is formed at the upper surface of the insulation layer 15 formed on the insulation layer 16. The pair of the electrodes 41 and 42 formed in a comb structure is printed in a predetermined pattern on the bottom surface of the insulation layer 15. The lead part 53a of the common electric field generating electrode 53 is connected to the electric field generation electrode terminal 74 formed at the bottom surface of the insulation layer 19 through a through hole 64 formed at the end part (at the right side in FIG. 5) of the insulation layers 15 to 19. The insulation layer 13 formed on the insulation layer 14 has the slit 20a corresponding to the PM detection electrode 3 composed of the pair of electrodes 31 and 32 formed in a comb structure. The detection space 2a is formed in the insulation substrate 13 between the insulation substrate 12 and the insulation substrate 14.

The pair of the electrodes 31 and 32 in the PM detection electrode 3 is printed in a predetermined pattern on the insulation layer 14. In the structure of the PM sensor element 1-1 shown in FIG. 5, the common terminal is used as one terminal of the PM detection electrode 3 and the one terminal of the PM detection electrode 4.

One part of each of the base parts 31a and 41a in the electrodes 31 and 41 formed in a comb structure is connected to a PM detection terminal 73 formed on the upper surface of the insulation layer 11 through a through hole 81 formed in the end part (at the right side in FIG. 5) of the insulation layers 12, 13, 14 and 15.

The other parts of the base parts 31a and 41a in the electrodes 31 and 41 in a comb structure are connected to PM detection terminals 74 and 75, respectively, formed on the upper surface of the insulation layer 11 through the through holes 82 and 83 formed in the end part (at the right side in FIG. 5) of the insulation layers 12, 13, 14 and 15.

The electric field generating electrode 51 is printed in a predetermined pattern on the insulation layer 12. The insulation layer 11 is laminated on the insulation layer 12. That is, the electric field generating electrode 51 is formed between the insulation layer 11 and the insulation layer 12. The lead part 51a of the electric field generating electrode 51 is connected to the electric field generating electrode terminal 76 formed on the upper surface of the insulation layer 11 through a through hole (not shown) formed at the end part (at the right side in FIG. 5) of the insulation layer 11.

After forming the heating film 61 at a predetermined position on the insulation substrate 19, the insulation substrates 11, 12, 13, 14, 15, 16, 17, 18 and 19 are laminated, as shown in FIG. 5. Thus, the insulation substrates 11, 12, 13, 14, 15, 16, 17, 18 and 19 have the PM detection electrodes 3 and 4, the electric field generating electrodes 51 and 52, the common electric field generating electrode 53, the through holes 63, 64 and 81 to 84, and the heating film 61. The obtained lamination is fired to make an assembled body of the PM sensor element 1-1 having the above structure. It is possible to produce the PM detection sensor 1-1 according to the first exemplary embodiment, as previously described, by the same method.

### (Experiment)

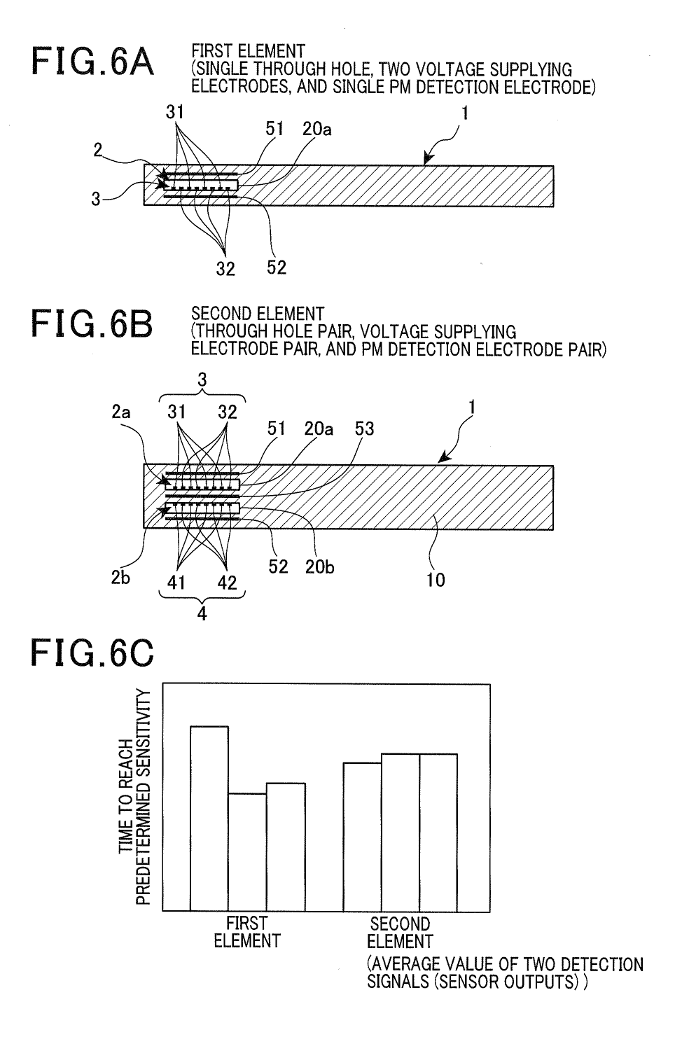

A description will now be given of the examples in order to evaluate the structure of the PM detection sensor according to the exemplary embodiment and a structure of a conventional PM detection sensor with reference to FIG. 6A and FIG. 6C.

The experiment used a first element and a second element.

FIG. 6A shows a cross section of the first element as a comparative element having a conventional structure, and FIG. 6B shows a cross section of the second element according to the exemplary embodiment of the present invention.

The second element has the structure shown in FIG. 6B which corresponds to the structure of the PM detection sensor S according to the first exemplary embodiment shown in FIG. 4B.

The second element having the structure shown in FIG. 6B is composed of the pair of the PM detection electrodes 3 and 4, and the pair of the electric field generating electrodes (composed of the pair of the electric field generating electrodes 51 and 52 and the common electric field generating electrode 53).

On the other hand, FIG. 6A shows the first example having a conventional structure as a comparative example composed of a single slit 20, a single PM detection electrode 3 and a pair of electric field generating electrodes 51 and 52. The single PM detection electrode 3 shown in FIG. 6A is composed of a pair of electrodes formed in a comb structure.

### (First Experiment)

The first element and the second element were placed in an exhaust gas pipe communicate with a diesel engine. Through the exhaust gas pipe, exhaust gas emitted from the diesel engine is discharged to the outside. During the working of the internal combustion engine, the first experiment detected the sensor output obtained from each of the first element and the second element during a predetermined period of time. The sensor output of the first element corresponds to the change in electric resistance between the electrodes of the PM detection electrode 3. The sensor output of the second element corresponds to the change in electric resistance between the electrodes in each of the PM detection electrodes 3 and 4.

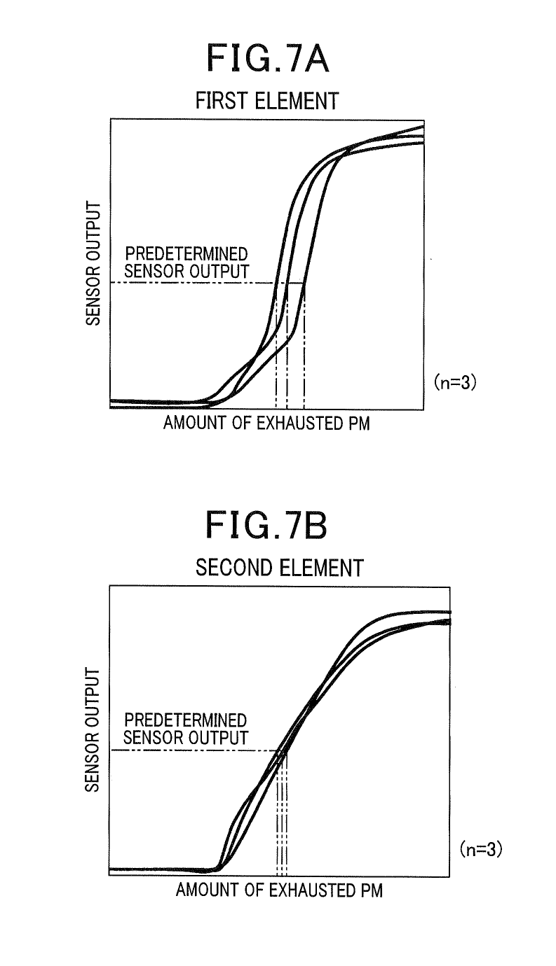

The first experiment was repeated three times. FIG. 7A and FIG. 7B show the experimental results. The quantity of PM contained in exhaust gas was detected by a PM analyzer. The slit 20 formed in the first element is equal in size to each of the slits 20a and 20b formed in the second element. The first experiment used the same supplying voltage to be supplied to the electric field generating electrodes. That is, the first experiment used the following conditions:

Height of each slit: 0.3 mm;

Width of each slit: 10 mm;

Supplying voltage (to be supplied to electric field generating electrodes): 30 V;

Engine: Diesel engine;

Engine speed (rotation speed): 2000 rpm; and

Quantity of smoke: 5%.

FIG. 7A is a view showing a relationship between a quantity of PM emitted from and a sensor output of the first element as the first example. FIG. 7B is a view showing a relationship between a quantity of PM emitted from the second element and a sensor output of the second element.

As shown in FIG. 7A and FIG. 7B, the first element and the second element outputted a sensor output of 0 V (in a non-detection period). When the pair of the electrodes in a comb structure in the PM detection electrodes in the first element and the second element was conducted at a time, the output of each of the first element and the second element was increased according to increasing of a quantity of PM contained in exhaust gas emitted from the diesel engine. The sensor output was then saturated at a saturation time. However, there is a difference in the non-detection period having no sensor output in the first element and the second element because the first element has the single PM detection electrode 3 composed of the pair of electrodes 31 and 32 formed in a comb structure, and the second element having the pair of the PM detection electrodes 3 and 4 in which each of the PM detection electrodes 3 and 4 is composed of the pair of electrodes 31 and 32 (41 and 42) formed in a comb structure.

That is, the first element was a fluctuation of the non-detection period, and a fluctuation of a slope of an increasing speed of the sensor output during the experiment.

On the other hand, the second sample has a small fluctuation of non-detection period, a small slope of an increasing speed of the sensor output and a small fluctuation for the sensor output to reach a predetermined sensor output during the experiment because the second element has the structure corresponding to the first exemplary embodiment and also corresponding to the second exemplary embodiment, previously described, and because the second element averaged the sensor output obtained from the pair of the PM detection electrodes, and outputted the averaged value as the sensor output.

FIG. 6C is a graph showing a fluctuation of a sensor output of the first element shown in FIG. 6A and the second element shown in FIG. 6B.

That is, FIG. 6C shows the time necessary for the sensor output of each of the first element and the second element to reach a predetermined sensor output (a predetermined sensitivity). The number “n” of experiments was three (n=3).

As clearly shown in FIG. 6C, the second element according to the exemplary embodiment of the present invention has approximately no significant fluctuation in the time required to reach the predetermined sensor output. On the other hand, the first element as a comparative example has a large fluctuation even if the experiment was performed under the same condition.

It is accordingly possible for the PM detection sensor S as the second element according to the exemplary embodiment of the present invention to detect the presence of PM contained in exhaust gas as a detection target with high accuracy when compared with the first element as the conventional element.

### (Second Experiment)

The second experiment made a breaking of a wire such as a lead part of an electrode in each of the first element and the second element. The second experiment detected the sensor output of each of the first element and the second element by the same method disclosed in the first experiment previously described.

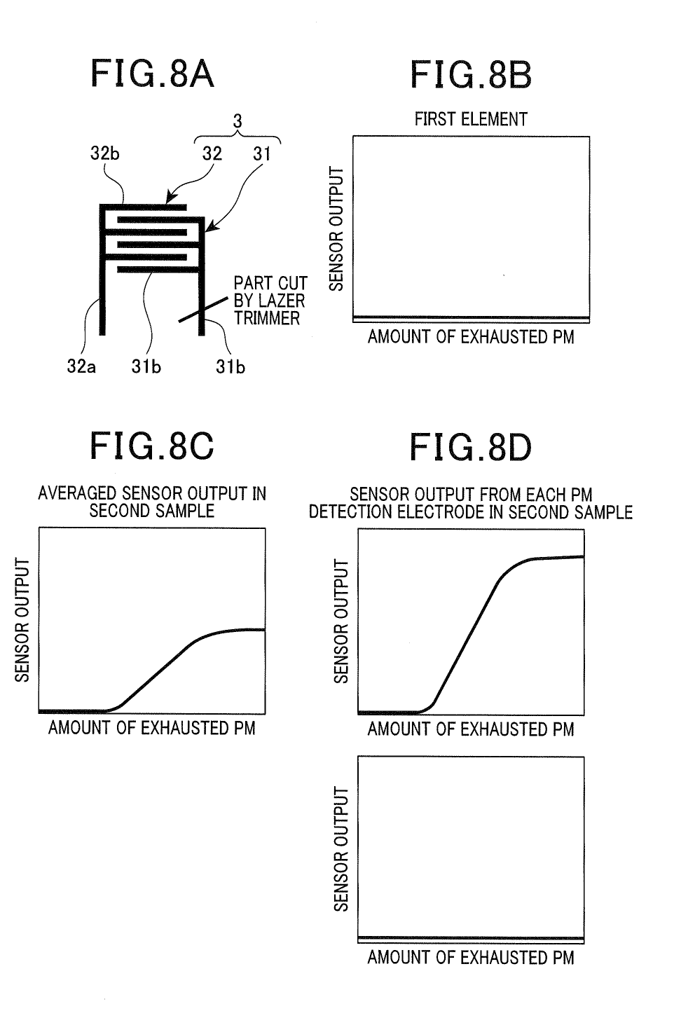

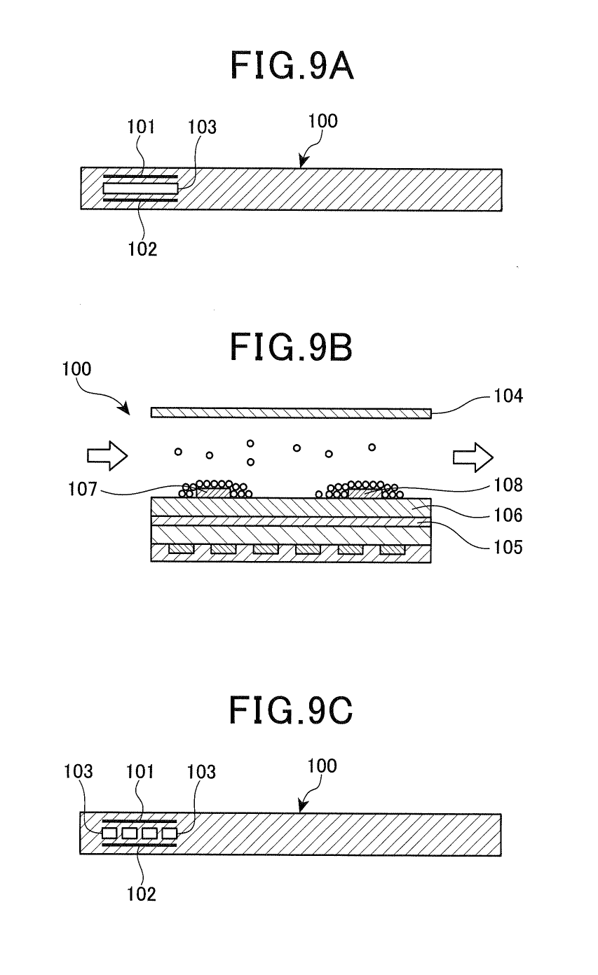

FIG. 8A is an explanatory view showing the process of making a breaking of a wire such as the lead part of an electrode in each of the first element and the second element by using a laser trimmer. FIG. 8B is a view showing a relationship between a quantity of PM contained in exhaust gas and a sensor output of the first element. FIG. 8C is a view showing a relationship between a quantity of PM contained in exhaust gas and an averaged sensor output supplied from the second element. FIG. 8D is a view showing a relationship between a PM contained in exhaust gas and a sensor output of the second element.

As shown in FIG. 8A, in the first element, a part of the lead part 31a of the single PM detection electrode 3 was cut by a laser trimmer.

On the other hand, in the second element, a part of the lead part 31a in the PM detection electrode 3 in the pair of the PM detection electrodes 3 and 4 was cut, but a part of the lead part 41a in the PM detection electrode 4 was not cut.

FIG. 8B shows the experimental result of the first element. Because the lead part 31a in the single PM detection electrode 3 was cut, the first element did not output any sensor output. It is therefore difficult on the basis of the experimental result to distinguish whether no PM was contained in exhaust gas or the first element did not output any sensor output by the breaking of the lead part 31a.

On the other hand, FIG. 8C shows that the second element outputted a half of a usual sensor output after the elapse of non-detection period when PM contained in exhaust gas because the sensor output shown in FIG. 8C was an average sensor output.

The upper view in FIG. 8D shows that the PM detection electrode 4 outputted a full sensor output through the lead part 41a after the elapse of non-detection period when PM contained in exhaust gas.

The lower view in FIG. 8D shows that the PM detection electrode 3 did not output any sensor output after the elapse of non-detection period even if PM contained in exhaust gas because the lead part 31a was cut by the laser trimmer.

Accordingly, the structure of the second element as the PM sensor element 1 according to the exemplary embodiment makes it possible to detect abnormal state by comparing two sensor outputs shown in the upper view and the lower view in FIG. 8D. For example, an external device such as an electric control unit (ECU) monitors the first sensor output from the PM detection electrode and the second sensor output from the other PM sensor electrode. When one sensor output is larger than the other sensor output, the external device can provide to the vehicle driver a warning of breaking wire in the PM detection sensor S. This makes it possible to improve and increase the reliability of on-board diagnosis (OBD) mounted to a motor vehicle.

### INDUSTRIAL APPLICABILITY

The PM detection sensor S according to the present invention can be applied to various applications, such as exhaust gas purifying devices for internal combustion engines such as diesel engines, in order to detect particulate matters contained in exhaust gas as a detection target. Specifically, the PM detection sensor S according to the exemplary embodiment is placed in the downstream side of a DPF in order to detect occurrence of abnormal state of the DPF. Still further, the PM detection sensor S according to the exemplary embodiment is also placed in the upstream side of the DPF in order to directly detect PM contained in exhaust gas which is introduced into the DPF.

### Features and Effects of the Exemplary Embodiments

As described above, the PM detection sensor S according to the exemplary embodiment of the present invention has the plurality number of the detection units. The pair of the electrodes 31 and 32 which forms the PM detection electrode 3 is formed in the inside of the corresponding slit 20a. Similarly, the pair of the electrodes 41 and 42 which forms the PM detection electrode 4 is formed in the inside of the corresponding slit 20b. When exhaust gas as a detection target is introduced into the inside of the slits 20a and 20b, the PM detection electrodes 3 and 4 detect PM contained in the exhaust gas which is entered only in the slits 20a and 20b. This structure of the PM detection sensor S according to the exemplary embodiment makes it possible to avoid and prevent such exhaust gas containing PM from directly attacking the PM detection electrodes 3 and 4 in the exhaust gas pipe. In other words, the exhaust gas is firstly entered in the inside of a hollow cover body 40 of the PM detection sensor S through a plurality of through holes 401 and 402 formed in a base part and a side part of the hollow cover body 40. The exhaust gas is then entered into the slits 20a and 20b formed in the insulation substrate 10 of the PM detection sensor S, and the exhaust gas reaches the PM detection electrodes 3 and 4. Thus, the structure of the PM detection sensor S according to the exemplary embodiment makes it possible for the exhaust gas to be indirectly entered into the slits 20a and 20b. This can prevent huge particles and condensed water contained in exhaust gas from being entered into the inside of the slits 20a and 20b as the detection spaces 2a and 2b, and from reaching the PM detection electrodes 3 and 4 composed of the electrodes 31, 32, 41 and 42 formed in a corn structure. This makes it possible to avoid wrong detection. Because the plurality of the slits 20a and 20b are arranged in the thickness direction of the insulation substrate 10, one slit 20a is sandwiched by one pair of the electric field generating electrode 51 and the common electric field generating electrode 53, and the other slit 20b is sandwiched by the other pair of the electric field generating electrode 52 and the common electric field generating electrode 53. In this structure, the common electric field generating electrode 53 is commonly used by the above electric field generating electrode pairs. This makes it possible to decrease the electrode area in the insulation substrate 10 and to easily form the electric field generating electrode pairs in the insulation substrate 10.

Still further, this structure of the PM sensor element 1 of the PM detection sensor S makes it possible to generate a stable electric field by using the electric field generating electrode pairs, and to promote the PM capturing capability.

Because an external device such as an electric control unit (ECU) receives sensor outputs transferred from the plurality of the PM detection electrodes 3 and 4, it is possible to detect the presence of PM contained in the exhaust gas on the basis of the received sensor outputs with high sensitivity and accuracy. This makes it possible to detect occurrence of fault of the DPF immediately. Still further, because the distance between the electric field generating electrodes faced to each other is small, it is possible to decrease electric power to be used for generating electric field in the slits 20a and 20b. This makes it possible to further reduce the detection cost.

In the PM detection sensor S, the PM sensor element 1 has a pair of the detection units. A pair of the slits 20a, 20b is formed in the insulation substrate 10 in order to form the pair of the detection units. One PM detection electrode 3 has a pair of the electrodes 31, 32 and is placed on the surface of the inner wall of one detection space 2a. On the other hand, the other PM detection electrode 4 has a pair of the electrodes 41, 42 and is placed on the surface of the inner wall of the other detection space 2b. The common electric field generating electrode 53 is embedded in the space between the slits 20a, 20b in the insulation substrate 10. One slit 20a is formed between one electric field generating electrode 51 and the common electric field generating electrode 53. The other slit 20b is formed between the other electric field generating electrode 52 and the common electric field generating electrode 53 so that the electric field generating electrode 51 and the electrodes composed of the common electric field generating electrode 53 make one electric field generating pair, and the electric field generating electrode 52 and the common electric field generating electrode 53 make the other electric field generating electrode pair.

Specifically, the two slits 20a and 20b make the two detection spaces 2a and 2b of the PM sensor element 1. Further, because the common electric field generating electrode 53 is formed between the two slits 20a and 20b, it is possible to easily form the two pairs of the electric field generating electrodes. This makes it possible to provide a uniform electric field in the twp detection spaces 20a and 20b. Because the PM detection electrode 3, 4 is formed on the surface of the inner wall of each of the slits 20a and 20b, it is possible to each of the PM detection electrodes 3, 4 can detect PM contained in the exhaust gas as a detection target with the same detection condition. Accordingly, it is possible to detect abnormal state of the PM detection sensor S by comparing the sensor outputs as the detection signals transferred from the PM detection electrodes 3 and 4. Because the ECU as the external device uses the averaged value of the sensor outputs as the detection signals, it is possible to detect PM contained in the exhaust gas, and to detect occurrence of fault of the PM detection sensor S with low fluctuation and high accuracy

In the PM detection sensor S, the electric field generating electrodes 51 and 52 other than the common electric field generating electrode 53 have the same electric pole in the electric field generating electrode pair. The electric field generating electrodes 51, 52 having the same electric pole are connected to a common electric terminal.

Specifically, the electric field generating electrodes 51, 52 have the same electric pole such as a positive pole, and the common electric field generating electrode 53 has the different pole such as a negative pole. That is, a negative voltage is supplied to the common electric field generating electrode 53, and a positive voltage is supplied both to the electric field generating electrodes 51, 52. This makes it possible for the PM detection electrodes 3 and 4 in the PM detection sensor S to detect PM contained exhaust gas under the same condition.

In the particulate matter PM detection sensor S, sensor outputs supplied from the plurality of the PM detection electrodes 3, 4 are averaged, and the averaged sensor output is used as a sensor output of the PM detection sensor S.

Specifically, the ECU uses an averaged value of the sensor outputs transferred from the PM detection electrodes 3 and 4 in the PM sensor element 1, it is possible to suppress the sensor outputs from being fluctuated. This makes it possible to detect PM of a less quantity contained in exhaust gas as a detection target. In other words, it is possible for the PM detection sensor S equipped with the PM detection element 1 having the above structure to detect the presence of PM passed through the DPF when malfunction of the DPF occurs.

In the particulate matter PM detection sensor S, an abnormal state of the PM detection electrodes 3, 4 is detected on the basis of a comparison result of the sensor outputs supplied from the plurality of the PM detection electrodes 3, 4.

It is possible to use the pair of the PM detection electrodes 3 and 4 in order to detect abnormal state of the PM detection sensor S. That is, because the pair of the PM detection electrodes 3 and 4 is used under the same detection condition, it is possible to judge that fault of one of the PM detection electrodes 3 and 4 occurs when a difference value between the detection signals transferred from the PM detection electrodes 3 and 4 is not less than a predetermined value.

In the particulate matter PM detection sensor S, the electric field generating electrode 51 and the common electric field generating electrode 53 generate an electric field within a range of 0.02 to 5 MV/m in the corresponding detection space 20a. The electric field generating electrode 52 and the common electric field generating electrode 53 generate an electric field within a range of 0.02 to 5 MV/m in the corresponding detection space 20b.

This makes it possible to detect the presence of PM contained in the exhaust gas as a detection target with high accuracy without increasing electric power to be supplied.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A particulate matter (PM) detection sensor equipped with a PM sensor element capable of detecting PM contained in exhaust gas as a detection target, the PM sensor element comprising an insulation substrate and a pair of PM detection electrodes formed in the insulation substrate, wherein the PM sensor element comprises a plurality of detection units, and
each of the detection units comprises:
a detection space formed in a slit which is penetrated through the insulation substrate, into which the exhaust gas is introduced;
the PM detection electrode comprised of a pair of electrodes formed on a surface of an inner wall of the slit which forms the detection space; and
a pair of an electric field generating electrode and a common electric field generating electrode by which electric field is generated in the inside of the detection space, and wherein the slits which form the detection units are arranged at a predetermined interval in a thickness direction of the insulation substrate, and one slit is sandwiched between the pair of the electric field generating electrode and the common electric field generating electrode and the other slit is sandwiched between the pair of the electric field generating electrode and the common electric field generating electrode, and
wherein the insulation substrate is placed in an exhaust gas flow during detection of PM contained in the exhaust gas, and PM contained in the exhaust gas is detected on the basis of detection results transferred from the pair of the PM detection electrodes.

2. The particulate matter (PM) detection sensor according to claim 1, wherein the PM sensor element comprises a pair of the detection units, a pair of the slits is formed in the insulation substrate in order to form the pair of the detection units, one PM detection electrode comprised of a pair of electrodes is placed on the surface of the inner wall of one detection space, and the other PM detection electrode comprised of a pair of electrodes is placed on the surface of the inner wall of the other detection space, the common electric field generating electrode is embedded in the space between the slits in the insulation substrate, one slit is formed between one electric field generating electrode and the common electric field generating electrode, the other slit is formed between the other electric field generating electrode and the common electric field generating electrode so that the electric field generating electrode and the electrodes composed of the common electric field generating electrode make one electric field generating pair, and the electric field generating electrode and the common electric field generating electrode make the other electric field generating electrode pair.

3. The particulate matter (PM) detection sensor according to claim 2, wherein the electric field generating electrodes other than the common electric field generating electrode have the same electric pole in the electric field generating electrode pair, and the electric field generating electrodes having the same electric pole are connected to a common electric terminal.

4. The particulate matter (PM) detection sensor according claim 1, wherein sensor outputs supplied from the plurality of the PM detection electrodes are averaged, and the averaged sensor output is used as a sensor output of the PM detection sensor.

5. The particulate matter (PM) detection sensor according to claim 1, wherein an abnormal state of the PM detection electrodes is detected on the basis of a comparison result of the sensor outputs supplied from the plurality of the PM detection electrodes.

6. The particulate matter (PM) detection sensor according to claim 1, wherein the electric field generating electrode and the common electric field generating electrode generate an electric field within a range of 0.02 to 5 MV/m in the corresponding detection space, and the electric field generating electrode and the common electric field generating electrode generate an electric field within a range of 0.02 to 5 MV/m in the corresponding detection space.

7. The particulate matter (PM) detection sensor according to claim 1, further comprises a heater part composed of insulation layers and a heating film formed between the insulation layers, wherein the heater part is directly below the pair of the PM detection electrodes and the electric field generating electrodes in the insulation substrate.
